(19) United States
(12) Patent Application Publication
(10) Pub. No.: US 2024/0162442 A1
(43) Pub. Date: May 16, 2024

(54) ELECTRODE FOR SODIUM/SULFUR BATTERY AND MANUFACTURING METHOD THEREFOR

(71) Applicant: INDUSTRY-ACADEMIC COOPERATION FOUNDATION GYEONGSANG NATIONAL UNIVERSITY, Jinju-si, Gyeongsangnam-do (KR)

(72) Inventors: Hyo Jun AHN, Jinju-si, Gyeongsangnam-do (KR); Kwon Koo CHO, Jinju-si, Gyeongsangnam-do (KR); Changhyeon KIM, Jinju-si, Gyeongsangnam-do (KR); Huihun KIM, Jinju-si, Gyeongsangnam-do (KR); Minjun SEONG, Jinju-si, Gyeongsangnam-do (KR); Minyeong JEON, Busan (KR)

(21) Appl. No.: 18/281,517

(22) PCT Filed: Mar. 11, 2022
(86) PCT No.: PCT/KR2022/003460

§ 371 Date: Sep. 11, 2023

(30) Foreign Application Priority Data
Mar. 11, 2021 (KR) 10-2021-0032091

(51) Int. Cl. H01M 4/60; H01M 4/02; H01M 4/38; H01M 10/054; H01M 50/609

(52) U.S. Cl. CPC H01M 4/604; H01M 4/381; H01M 10/054; H01M 50/609; H01M 2004/027; H01M 2004/028

(57) ABSTRACT

Provided is a cathode for a sodium/sulfur (NaS) battery. The cathode includes polysodium-sulfide polyacrylonitrile (NaₓS-PAN, 3≤x) obtained by reaction with a large amount of sodium, and is a high-capacity electrode manufactured via sodiation to inject sodium.

### TECHNICAL FIELD

The present disclosure relates to an electrode for sodium/sulfur battery and a method of manufacturing the same, and more particularly, to a cathode for sodium/sulfur battery, having improved capacity via sodiation, and a method of manufacturing the same.

### BACKGROUND ART

Recently, mobile devices such as smartphones have become more multifunctional, and interest in developing high-capacity batteries has increased accordingly.

In addition, research on high-capacity batteries is being actively conducted for application to storage devices for renewable energy such as wind, sunlight, and solar heat or power devices for electric vehicles.

A battery is a device that converts chemical energy into electrical energy and consists of a cathode, an anode, and an electrolyte, and the cathode (a material with a low potential) and the anode (a material with a high potential) are distinguished by a relative potential difference from ionic materials being exchanged. The cathode and the anode are collectively referred to as an electrode, and the electrode includes an active material that causes an electrochemical reaction.

In particular, lithium secondary batteries are the most widely used, but due to an increase in raw material prices for lithium secondary batteries, research on inexpensive next-generation batteries is required. Among them, room-temperature sodium/sulfur (NaS) batteries that use sulfur as an active material have inexpensive raw materials, and are being actively researched due to their high theoretical energy density.

The reaction mechanism of room-temperature sodium/sulfur batteries is as follows, and sulfur has a high theoretical capacity of 1,672 mAh/g.

S+2Na→Na₂S

However, in nature, sulfur is in the form of a crown ring having eight S atoms bonded together, and accordingly, during electrochemical reaction with sodium, sulfur reacts in stages slowly from Na₂S₈ to Na₂S. High-order sodium polysulfide {Na₂Sₓ (4≤x≤8)} formed at this time dissolves into a liquid electrolyte. As a result, room-temperature sodium/sulfur batteries exhibit rapid self-discharge, low discharge capacity and poor cycle performance. In addition, sodium polysulfide dissolved in the liquid electrolyte causes a shuttle phenomenon in which oxidation and reduction are repeated while sodium polysulfide moves between a sulfur cathode and a sodium anode during charging, which causes a problem of high overcharge.

To solve this problem, a method of complexing sulfur with carbon, the use of solid electrolytes to block poly sulfide, etc. have been studied.

Among them, excellent cycle characteristics have been reported in electrodes using sulfurized polyacrylonitrile (S-PAN), which is manufactured by thermally bonding polymer polyacrylonitrile (PAN) and sulfur together, and a carbonate-based electrolyte with low solubility of high-order sodium polysulfide. However, even in these studies, only capacities lower than the theoretical capacity of sulfur have been reported.

In order to improve the utilization of sulfur, that is, the capacity of sulfur, attempts have been made to reduce the particle size of active materials and to achieve complexation with conductive materials. However, these methods have not only significantly increased the unit cost of a manufacturing process, but have also failed to improve actual capacity.

Therefore, there is a need for a method to reduce electrode manufacturing costs and efficiently improve capacity at the same time.

### DISCLOSURE

### Technical Problem

The present disclosure is in response to the above-described need, and the present disclosure aims to provide a cathode for a sodium/sulfur battery, having improved capacity via sodiation, and a method of manufacturing the same.

### Technical Solution

To achieve the above objective, a cathode for a sodium/sulfur (NaS) battery according to an embodiment of the present disclosure includes a polysodium-sulfide polyacrylonitrile (NaₓS-PAN, 3≤x).

In this case, the cathode may include no other additives other than polyacrylonitrile, sulfur, and sodium.

Meanwhile, the cathode may further include a conductive material.

Meanwhile, the cathode may have a structure in which sulfur and sodium are bonded with web-shaped polyacrylonitrile.

Meanwhile, a method of manufacturing a cathode for a sodium/sulfur battery according to an embodiment of the present disclosure includes adding sulfur (S) to polyacrylonitrile (PAN), obtaining a S-PAN composite in which sulfur and polyacrylonitrile are bonded together via heat treatment, and injecting sodium into the S-PAN composite by manufacturing a cell in which the S-PAN composite is used as a cathode and a sodium electrode is used as an anode, and by applying a voltage for charging and discharging to the cell.

In this case, a lowest limit of a range of the voltage to be applied in the injecting of sodium may be 0.7 V or less.

Meanwhile, a range of the voltage to be applied in the injecting of sodium may be a V to b V, and 0<a≤0.7 and 3≤b≤3.5 may be satisfied.

Meanwhile, a range of the voltage to be applied in the injecting of sodium may be 0.001 V to 3.5 V.

Meanwhile, the method may further include, after the injecting of sodium, injecting additional sodium into the S-PAN composite via a constant-voltage method.

### DESCRIPTION OF DRAWINGS

FIG. 1 is a diagram of an example of a molecular structure of a S-PAN composite.

FIG. 2 is a diagram for explaining an example of a process for manufacturing an electrode by using a S-PAN composite.

FIG. 3 is a diagram for explaining a reaction voltage of sodiation according to the present disclosure.

FIG. 4 is an XPS result curve for explaining that sodium reacted with N of S-PAN during a reaction of the initial one sodium.

FIG. 5 is a charge/discharge curve for explaining that sodium irreversibly reacted during a reaction of the initial one sodium.

FIG. 6 is a charge/discharge curve for explaining that even when two sodiums reacted, the initial one reacted irreversibly.

FIG. 7 is a molecular schematic diagram of an example of a S-PAN composite when two sodiums or less reacted.

FIG. 8 is a molecular schematic diagram of an example of a S-PAN composite when at least three sodiums reacted.

FIG. 9 is a resistance change curve according to sodiation to explain that the electrical conductivity of a S-PAN cathode is improved via a sodiation process.

FIG. 10 is a diagram for explaining sodiation according to an embodiment of the present disclosure.

FIG. 11 shows the shape and element distribution of an electrode according to Example 1 of the present disclosure.

FIG. 12 is a charge/discharge curve of the electrode according to Example 1 of the present disclosure.

FIG. 13 is a charge/discharge curve of an electrode according to Comparative Example 1 of the present disclosure.

FIG. 14 is an electrochemical characteristics comparison curve for Comparative Example 1 and Example 1 of the present disclosure.

FIG. 15 shows cycle characteristics of the electrode according to Example 1 of the present disclosure.

FIG. 16 shows power characteristics of the electrode according to Example 1 of the present disclosure.

FIG. 17 shows data from comparing various previous research results of the electrode according to Example 1 of the present disclosure and a sulfur cathode for a room-temperature sodium/sulfur battery.

FIG. 18 shows mechanism analysis data via XPS of the electrode according to Example 1 of the present disclosure.

FIG. 19 is a scanning electron microscope (SEM) image of an electrode according to Example 2 of the present disclosure.

### MODE FOR INVENTION

Hereinafter, detailed embodiments of the present disclosure are described. However, the spirit of the present disclosure is not limited to the presented embodiments. Those skilled in the art who understand the spirit of the present disclosure will be able to easily suggest other embodiments or other embodiments included within the scope of the spirit of the present disclosure by adding, changing, or deleting other components within the scope of the same spirit, and these will also be included within the scope of the present disclosure.

Among the terms used in the present disclosure, terms defined in general dictionaries may be interpreted to have meanings that are the same as or similar to the meanings they have in the context of the related art, and unless clearly defined in the present disclosure, are not to be interpreted to have ideal or excessively formal meanings. If terms are not defined in detail, the terms may be interpreted based on the overall description of the present specification and common technical knowledge in the related art.

In addition, throughout the disclosure, terms including ordinal numbers such as “first”, “second”, etc. may be used to distinguish between components. These ordinal numbers are used to distinguish identical or similar components from each other, and the meanings of the terms should not be interpreted limitedly due to the use of these ordinal numbers. For example, the order of use or arrangement of components combined with these ordinal numbers should not be limited by the numbers. If necessary, each ordinal number may be used interchangeably.

Throughout the present disclosure, the expression of singularity includes the expression of plurality unless clearly specified otherwise in context. In the present application, it is to be understood that the terms such as “including,” “having,” “comprising,” and “consisting of” are intended to indicate the existence of the features, numbers, steps, actions, components, parts, or combinations thereof, and are not intended to preclude the possibility that one or more other features, numbers, steps, actions, components, parts, or combinations thereof may exist or may be added.

The present disclosure relates to a cathode for a room-temperature sulfur/sodium battery and a method of manufacturing the same, and hereinafter, the present disclosure is described in detail.

Room-temperature sulfur/sodium batteries are characterized by using solid electrode materials. Compared to high-temperature sulfur/sodium batteries using liquid electrode materials, there are advantages in that stability is excellent and high energy costs to maintain high temperatures are not required.

Room-temperature sulfur/sodium batteries use sulfur for cathodes and sodium for anodes. Because sulfur is a non-conductor, there is a method of manufacturing a cathode by mixing sulfur with a binder and a conductive material that provides conductivity, but in the case of cathodes manufactured in this way, there is a problem in that the actual discharge capacity is lower than the theoretical discharge capacity because conductive materials, binders, etc. are present in addition to sulfur which is an active material participating in the actual battery reaction.

Therefore, in order to implement an actual high-performance sulfur battery that is close to the theoretical energy density, it is desirable to manufacture an electrode without other additives such as a binder so as to increase the proportion of sulfur, which is an active material, within the electrode.

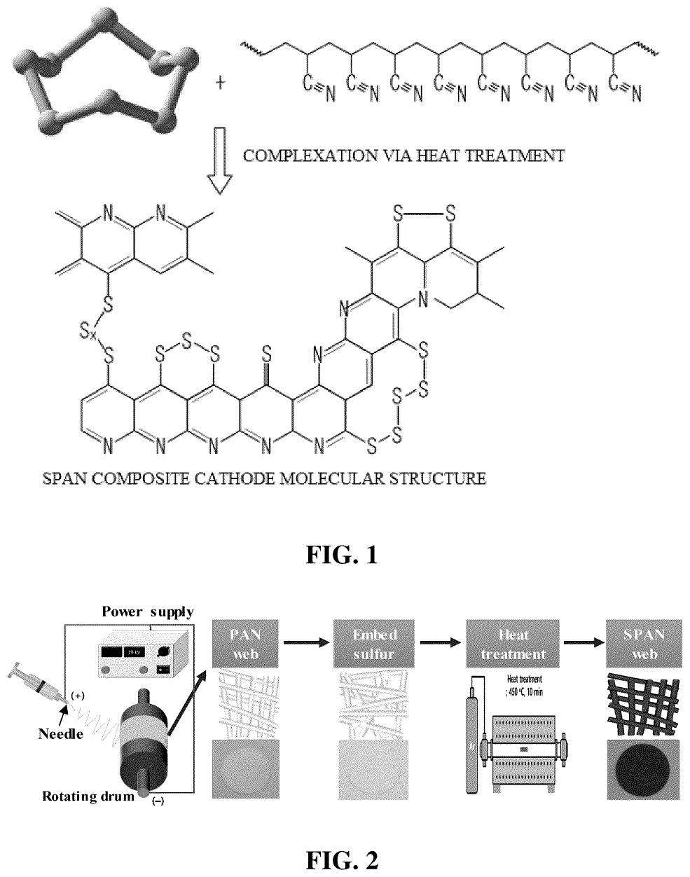

Among cathode active materials using sulfur, there is a sulfur-polyacrylonitrile composite (hereinafter, referred to as a S-PAN composite). Polyacrylonitrile (hereinafter, referred to as PAN) has no electrical conductivity, and sulfur is added to the PAN, followed by heat treatment to manufacture a S-PAN composite. However, the S-PAN composite has conductivity and is in the form of sulfur bonded inside a carbon ring of PAN, i.e. PAN structure, which minimizes sulfur leakage into an electrolyte, and because the S-PAN composite has a plurality of pores, there is little electrode deformation even after numerous charging and discharging, and its shape may be maintained without a binder. FIG. 1 shows an example of a molecular structure of a S-PAN composite.

A cathode for a sodium/sulfur battery of the present disclosure is manufactured by using a binder-free S-PAN composite, and in particular, performing sodiation to inject sodium into the S-PAN composite.

In other words, a method of manufacturing a cathode for a sodium/sulfur battery according to the present disclosure consists of a first step of manufacturing an electrode by using a S-PAN composite and a second step of performing sodiation on the electrode. Hereinafter, a manufacturing method consisting of the first step and the second step is described in detail.

[First Step] Manufacture of Electrode of S-PAN Composite

An electrode of a S-PAN composite is a binder-free electrode and may be manufactured to have various shapes via various manners. FIG. 2 is a diagram for explaining an example of a process for manufacturing an electrode by using a S-PAN composite. In the present example, PAN is formed to have a web shape via electrospinning, and sulfur is added to PAN, to manufacture an electrode.

In detail, referring to FIG. 2, PAN is dissolved in a dimethylformamide (N, N-Dimethylformamide; DMF) solvent, and then the solution is put into a syringe equipped with a metal needle. Then, a high voltage is applied between the needle and a rotating drum, and the solution is sprayed into the rotating drum through the needle. The sprayed solution is seated on the drum in the form of a thread, and the thread-shaped PAN may gather to form a web-shaped PAN. The web-shaped PAN formed via electrospinning is taken off from the drum.

Afterwards, sulfur is added to the web-shaped PAN. As a method of adding sulfur, sulfur may be added by passing the web-shaped PAN through a crucible in which sulfur is molten. Alternatively, sulfur may be added by sprinkling sulfur powder onto the web-shaped PAN. It is possible to use both methods.

At this time, although not essential, a conductive material may be optionally added to increase electrical conductivity. For example, as the conductive material, multiwalled carbon nanotube (MWCNT) powder may be added to the web-shaped PAN together with sulfur. A composite may have improved electrochemical characteristics when manufactured using a conductive material in addition to sulfur and PAN, compared to when the composite is manufactured using only sulfur and PAN.

Afterwards, heat treatment is performed. Via the heat treatment at a high temperature of at least 300° C., PAN and sulfur may be bonded together to form a S-PAN composite. The temperature and time condition of the heat treatment may be determined depending on a condition under which sulfur and PAN are bonded together. Once the heat treatment is completed, an electrode of a web-shaped S-PAN composite may be obtained.

Meanwhile, in the example described above, sulfur is added after PAN is manufactured to have a web shape via electrospinning. However, according to another example, sulfur may be added to a solution in which PAN is dissolved, followed by electrospinning in the same manner as previously described.

Meanwhile, in addition to electrospinning, dry spinning, wet spinning, etc. may be used, and in addition to a web shape, other various shapes such as a fabric shape may be made. Furthermore, in addition to these spinning methods, electrodes may be manufactured to have various shapes such as a coin shape via a process for filling PAN and S into a mold having a specific shape.

In addition to the description provided above, a method of manufacturing a binder-free S-PAN composite electrode disclosed in the present inventor's existing patents, Korean Registration Patent No. 10-1609571 and Korean Registration Patent No. 10-1656406, is also incorporated into the description of the present specification.

[Second Step] Sodiation on Electrode of S-PAN Composite

After the first step, sodiation is performed to inject sodium into the electrode of the S-PAN composite.

The sodiation may be performed via an electrochemical method. In detail, when the electrode of the S-PAN composite is used as a cathode and a sodium anode is used as a counter electrode to form a cell, and a sodium insertion and desorption process is repeated a predetermined number of times by applying, to the cell, a current within a voltage range under specific conditions, sodium may be injected into the electrode of the S-PAN composite. The greater the amount of sodium injected, the better the electrical conductivity and electrochemical activity.

Generally, S-PAN cathodes for sodium/sulfur batteries undergo electrochemical reactions near 2.1 V which is the equilibrium potential of sodium and sulfur. At this time, the charging/discharging cut-off voltage ranges from about 0.7 V to about 3.0 V, and only a reaction of sulfur is induced and used via this voltage range. At this time, it has been reported that S-PAN cathodes for sodium/sulfur batteries always reacts with less than two sodiums, whereas theoretically, S-PAN cathodes may react with two sodiums (NaₓS-PAN (x<2)).

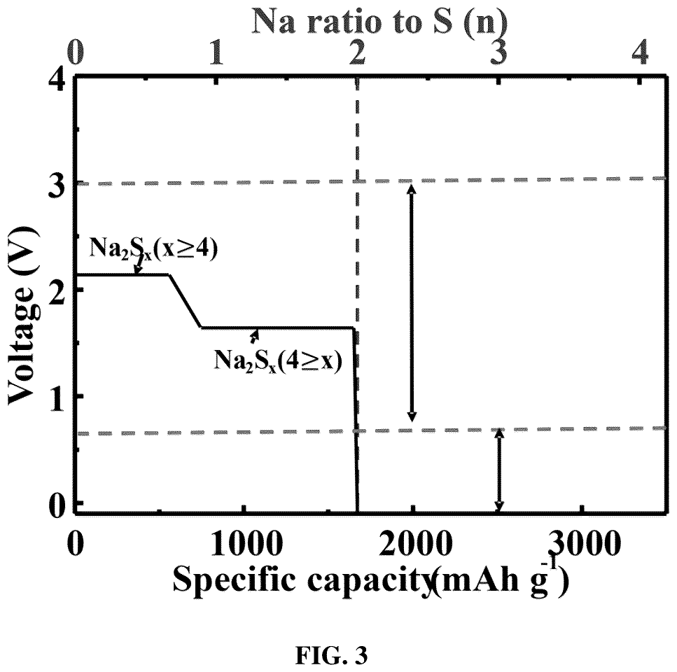

Therefore, improvement is required to allow more than two sodiums to react. As a result of experiments for this, it was found that when the reaction was carried out up to the lowest possible voltage range, unreacted sulfur reacted additionally with sodium. In detail, down to about 0.7 V, usually two sodiums or less react, but below about 0.7 V, additionally, sodium reacts with sulfur. Therefore, the lowest limit of a range of a voltage used in sodiation according to the present disclosure is less than or equal to 0.7 (see FIG. 3).

Referring to FIG. 3, in a range of about 0.7 V to about 3 V, which is the range of the long arrow, two sodiums or less react (indicated by the blue dotted line), whereas in a range of about 0.001 V to about 0.7 V, which is the range of the short arrow, additional sodium reacts. Therefore, when the reaction is carried out at a voltage in a range of a V to b V, at least three sodiums may react, wherein 0<a≤0.7 and 3≤b≤3.5 are satisfied. For example, when the reaction is carried out at about 0.001 V to about 3.5 V, at least three sodiums may react.

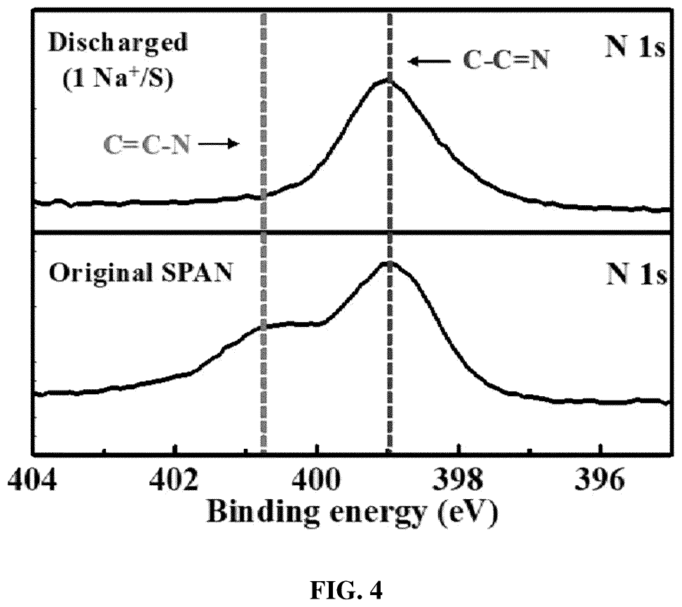

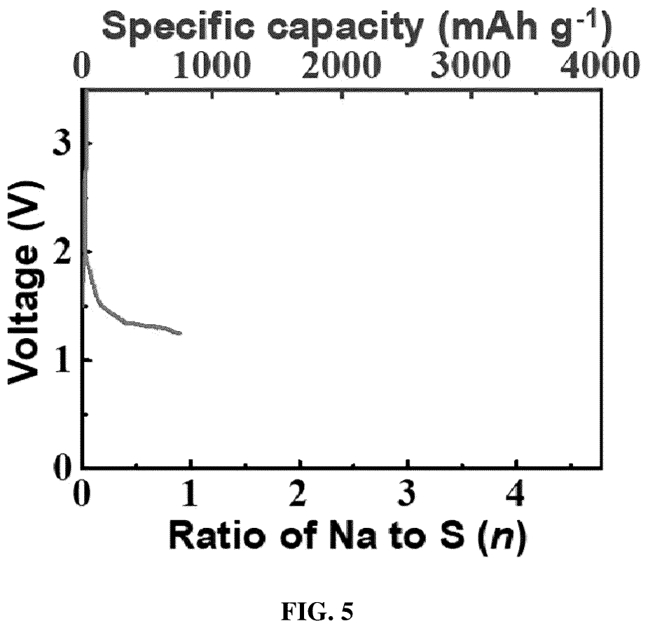

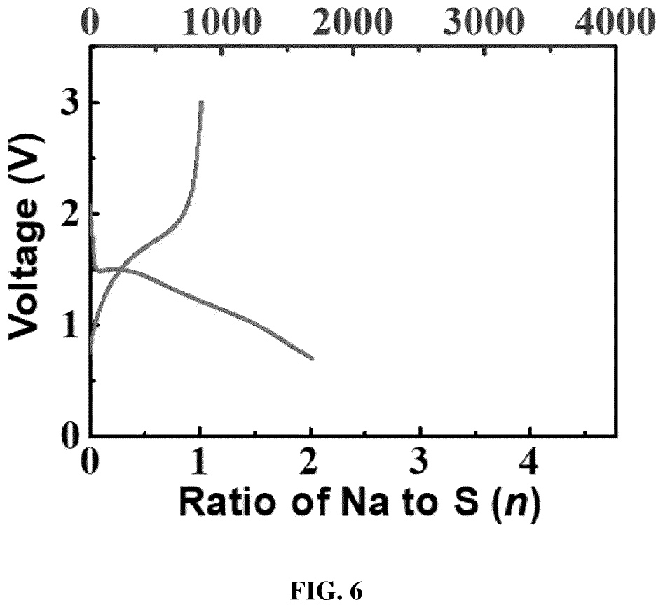

For a deeper understanding, it is necessary to clearly understand a process by which S-PAN is subjected to sodiation. In the initial cycle, when S-PAN reacts with sodium, sodium does not react with sulfur first, but reacts with N of a S-PAN structure (see FIG. 4). At this time, the number of sodiums that reacts is about 1, which is an irreversible reaction and thus does not appear in the next reaction (see FIG. 5). The irreversible reaction between sodium and N of the S-PAN structure appears the same even when two sodiums reacts with N of the S-PAN structure (see FIG. 6). Due to the irreversible reaction, when the cut-off voltage is 0.7 V, sulfur and sodium may not react with each other completely. Therefore, additionally, sulfur is activated via sodiation down to a cut-off voltage of 0.001 V, and after the sodiation, sulfur is able to react at above 0.7 V.

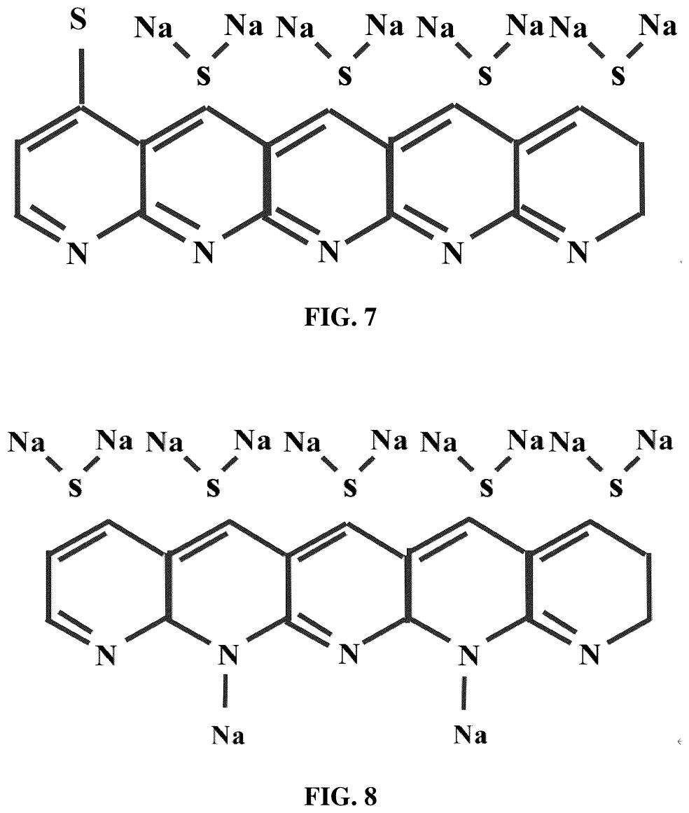

FIG. 7 is a molecular schematic diagram of an example of a S-PAN composite when two sodiums or less reacted, and FIG. 8 is a molecular schematic diagram of an example of a S-PAN composite when at least three sodiums reacted. The S-PAN composite when two sodiums or less reacted may be represented by a molecular formula of NaₓS-PAN (x<2). The S-PAN composite when at least three sodiums reacted is polysodium-sulfide polyacrylonitrile and may be represented by a molecular formula of NaₓS-PAN (3≤x).

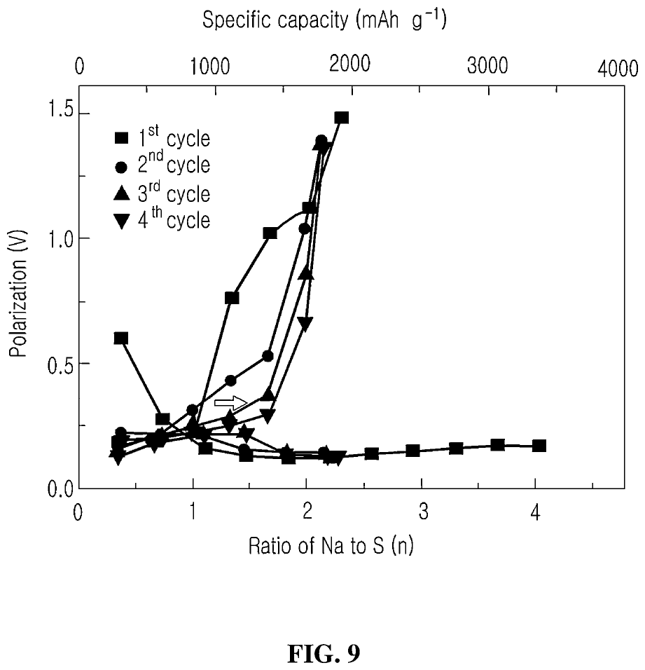

An effect obtained by performing sodiation (activation) of sulfur of S-PAN may be confirmed via FIG. 9. In FIG. 9, a change in internal resistance during a reaction between S-PAN and sodium is determined and shown as a difference between a voltage of a dormant period and a voltage at the time of the reaction. The greater the magnitude of the voltage of the dormant period and the magnitude of the voltage at the time of the reaction, the higher the internal resistance. It may be confirmed that the initially high internal resistance rapidly decreases as sodium reacts with N of S-PAN, and the low resistance continues to be maintained. It may be confirmed that during charging, as sodium escapes, the internal resistance increases, but one sodium still remains inside S-PAN, and accordingly, during the next discharging, the resistance rapidly decreases. Through this effect, polysodium-sulfide polyacrylonitrile (NaₓS-PAN (3≤x)) may have improved electrical conductivity and improved capacity via additional electrochemical sodium insertion beyond sodium (two sodiums) with which polysodium-sulfide polyacrylonitrile may theoretically react.

Meanwhile, after the sodiation, additional sodium may be injected to the S-PAN composite via a constant-voltage method.

Hereinafter, experimental results of an electrode on which sodiation is not performed and electrodes on which sodiation is performed by differing a voltage range are described.

1) Electrode of Comparative Example 1

As described above, a web-shaped PAN was manufactured via electrospinning, and sulfur was added to the PAN, followed by heat treatment under an argon (Ar) atmosphere at 450° C. for 10 minutes to manufacture an electrode. In other words, the electrode of Comparative Example 1 was not subjected to sodiation.

2) Electrode of Comparative Example 2

The electrode manufactured as in Comparative Example 1 was used as a cathode, a sodium anode was used as a counter electrode, glass fiber (GF/D)+celgard 2400 separation membrane and carbonate electrolyte 1 M NaPF6+EC/DEC (1:1. v/v) were used to manufacture a cell, and a sodium insertion/desorption process (sodiation) was repeated about 5 times at a voltage range of about 0.7 V to about 3 V at 0.16 C-rate.

3) Electrode of Example 1

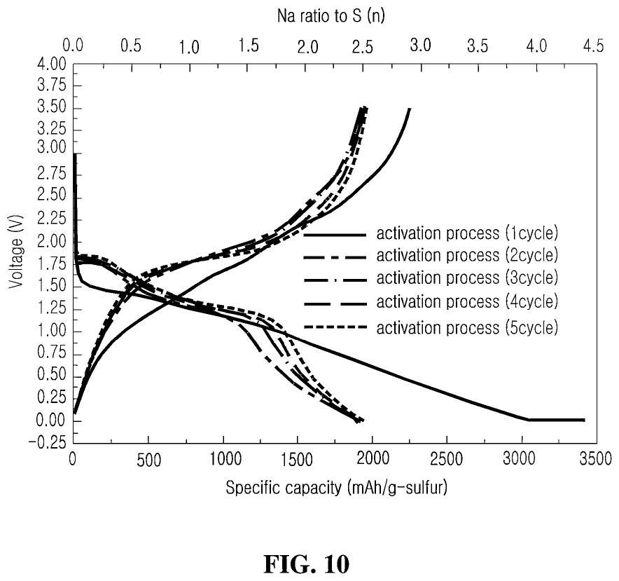

The electrode manufactured as in Comparative Example 1 was used as a cathode, a sodium anode was used as a counter electrode, glass fiber (GF/D)+celgard 2400 separation membrane and carbonate electrolyte 1 M NaPF6+EC/DEC (1:1. v/v) were used to manufacture a cell, and a sodium insertion/desorption process (sodiation) was repeated about 5 times at a voltage range of about 0.001 V to about 3.5 V at 0.16 C-rate (see FIG. 10. one cycle in which sodium is inserted and desorbed is referred to as an activation process).

3) Electrode of Example 2

In addition to a method of manufacturing the electrode of Example 1, as a conductive material, carbon nanotube (CNT) powder was added to the web-shaped PAN together with sulfur to manufacture an electrode.

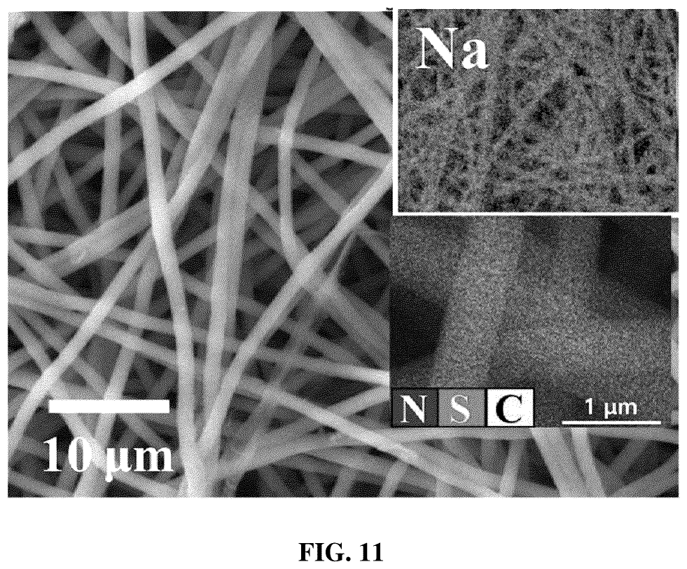

FIG. 11 shows the shape and element distribution of the electrode according to Example 1. As a result of element distribution analysis, it may be confirmed that in addition to C, N, and S, which are elements included in existing S-PAN, Na molecules are evenly distributed.

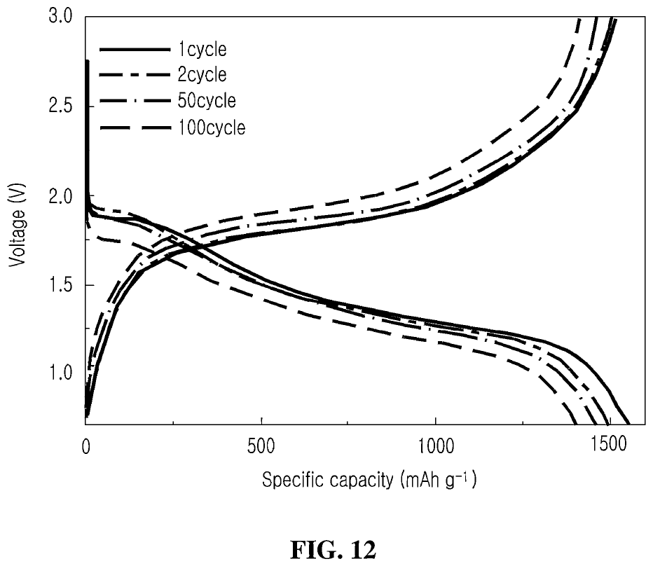

FIG. 12 is a charge/discharge curve of the electrode according to Example 1, and it may be confirmed that the capacity per sulfur is 1,558 mAh/g, which amounts 93% of the theoretical capacity.

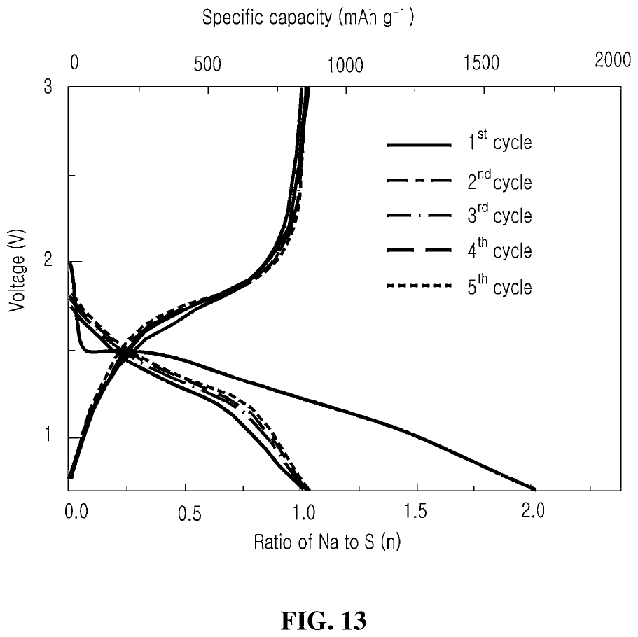

FIG. 13 is a charge/discharge curve of the electrode according to Comparative Example 1, and it may be confirmed that without sodiation, a low capacity of 844 mAh/g is shown.

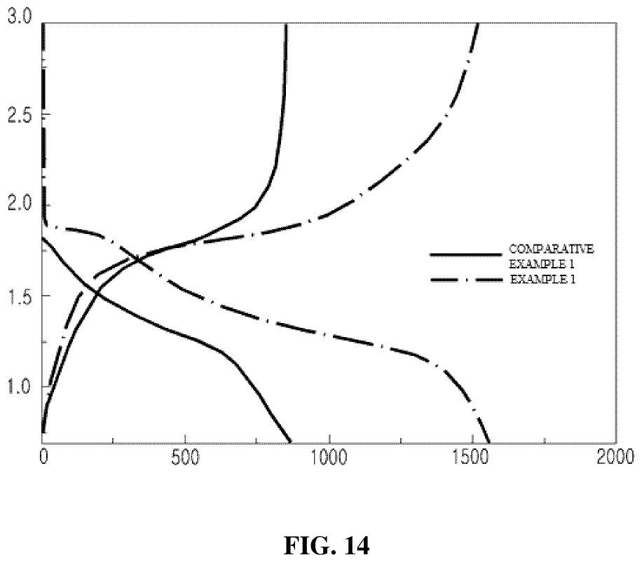

FIG. 14 is a result of comparing electrochemical characteristics of Comparative Example 1 and Example 1. It may be confirmed that the operating voltage and the capacity during charging/discharging are significantly improved via a large amount of sodiation.

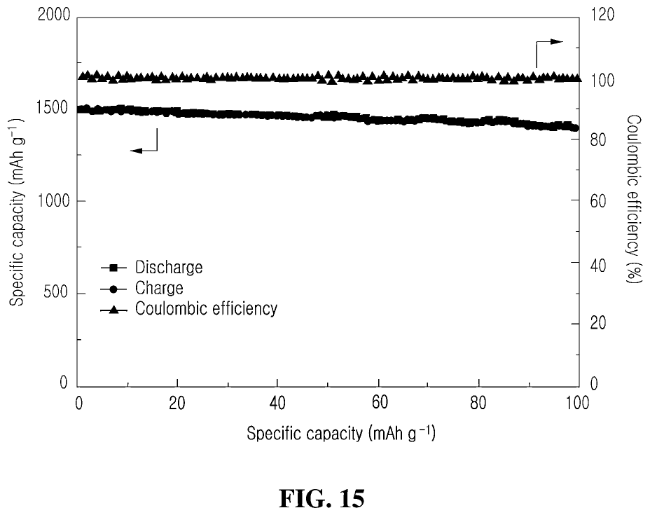

FIG. 15 shows cycle characteristics of the electrode according to Example 1, and it may be confirmed that after 100 cycles, the capacity is 1,405 mAh/g, showing a high capacity retention rate of about 90%.

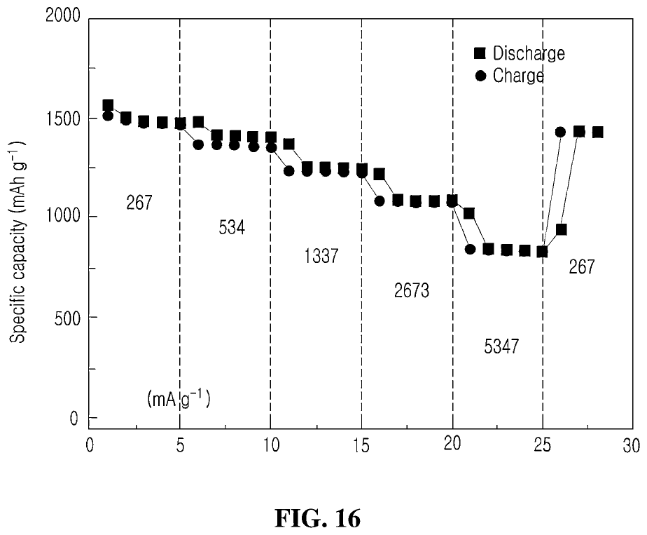

FIG. 16 shows power characteristics of the electrode according to Example 1, and it may be confirmed that a high capacity of 834 mAh/g is shown at a high current density of about 5 A/g.

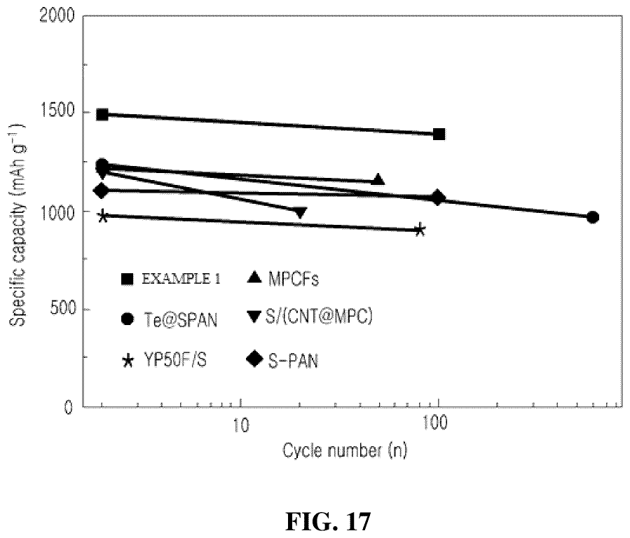

FIG. 17 shows data from comparing various previous research results of the electrode according to Example 1 and a sulfur cathode for a room-temperature sodium/sulfur battery, and the electrode of Example 1, which has undergone a sodiation process, exhibits the best capacity characteristics among all sulfur cathode researches.

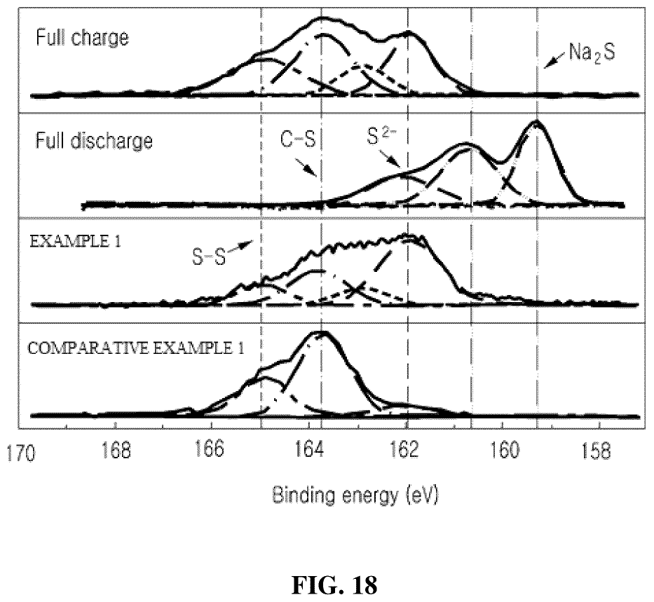

FIG. 18 shows mechanism analysis data via XPS of the electrode according to Example 1. It may be confirmed that the electrode of Comparative Example 1 subjected to sodiation is the electrode of Example 1, and that when sodium is discharged, Na₂S is generated, and when sodium is charged, returned to S-PAN.

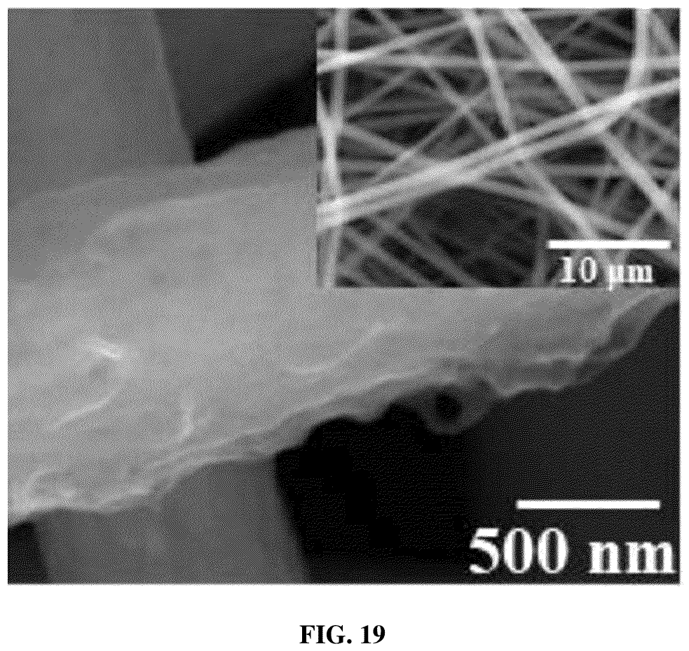

FIG. 19 is an SEM image of the electrode according to Example 2. The electrode according to Example 2 may exhibit superior electrochemical characteristics by obtaining synergy between the efficacy of electrochemical sodiation and the efficacy of high conductivity of MWCNT.

According to the present disclosure, the limited capacity of an existing sulfur cathode may be improved via sodiation, and an electrode with high capacity, high power, and high stability may be obtained. In addition, the sodiation is a simple and easy electrochemical method, and thus may reduce electrode manufacturing costs.

Hereinbefore, preferred embodiments of the present disclosure are shown and described, but the present disclosure is not limited to the specific embodiments described above, and various modifications and implementations can be made by those skilled in the art without departing from the gist of the present disclosure as defined by the appended claims, and these modifications and implementations should not be understood individually from the technical idea of the present disclosure.

1. A cathode for a sodium/sulfur (NaS) battery, the cathode comprising polysodium-sulfide polyacrylonitrile (NaₓS-PAN, 3≤x).

2. The cathode of claim 1, wherein the cathode comprises no other additives other than polyacrylonitrile, sulfur, and sodium.

3. The cathode of claim 1, further comprising a conductive material.

4. The cathode of claim 1, wherein the cathode has a structure in which sulfur and sodium are bonded with web-shaped polyacrylonitrile.

5. A method of manufacturing a cathode for a sodium/sulfur (NaS) battery, the method comprising:
adding sulfur (S) to polyacrylonitrile (PAN);
obtaining a S-PAN composite in which sulfur and polyacrylonitrile are bonded together via heat treatment; and
injecting sodium into the S-PAN composite by manufacturing a cell in which the S-PAN composite is used as a cathode and a sodium electrode is used as an anode, and by applying a voltage for charging and discharging to the cell.

6. The method of claim 5, wherein a lowest limit of a range of the voltage to be applied in the injecting of sodium is 0.7 V or less.

7. The method of claim 5, wherein a range of the voltage to be applied in the injecting of sodium is a V to b V, and
0<a≤0.7 and 3≤b≤3.5 are satisfied.

8. The method of claim 5, wherein a range of the voltage to be applied in the injecting of sodium is 0.001 V to 3.5 V.

9. The method of claim 5, further comprising, after the injecting of sodium, injecting additional sodium into the S-PAN composite via a constant-voltage method.
